(19) United States
(12) Patent Application Publication
(10) Pub. No.: US 2016/0349103 A1
(43) Pub. Date: Dec. 1, 2016

(54) MANAGING A DISTRIBUTION OF A PAYLOAD FOR A FLIGHT

(71) Applicants: Chet R. CREACY, Bellevue, WA (US); Anthony Samy JAYAPAL, Mooresville, NC (US); Matthew COLEGROVE, Fairport, NY (US); Hao CUI, Wuhan, Hubei (CN); John Martin EVANS, Fort Collins, CO (US); David Brook BANNING, Fort Collins, CO (US); Don MCHODGKINS, Fort Collins, CO (US); Rammohan THANIKACH-ALAM, Miramar, FL (US); Carrie RANGEEN, Coraopolis, PA (US); Laura C. TRUITT, Houston, TX (US); David Woodman GOULD, Apex, NC (US); David PEREZ, Plano, TX (US); Mark J. SCRIFFINY, Fort Collins, CO (US); Michelle Lynn Hill DAUM, Brighton, CO (US); HEWLETT-PACKARD DEVELOPMENT COMPANY, L.P., Houston, TX (US)

(72) Inventors: Chet R. Creacy, Miramar, FL (US); Antony Samy Jayapal, Mooresville, NC (US); Matthew Colegrove, Fairport, NY (US); Hao CUI, Hubei (CN); John Martin Evans, Fort Collins, CO (US); David Brook Banning, Fort Collins, CO (US); Don McHodgkins, Fort Collins, CO (US); Rammohan Thanikachalam, Miramar, FL (US); Carrie Rangeen, Coraopolls, PA (US); Laura C. Truitt, Houston, TX (US); David Woodman Gould, Apex, NC (US); David Perez, Plano, TX (US); Mark J. Scriffiny, Fort Collins, CO (US); Michelle Lynn Hill Daum, Brighton, CO (US)

(21) Appl. No.: 15/111,776

(22) PCT Filed: Jan. 15, 2014
(86) PCT No.: PCT/CN2014/070659

§ 371 Date: Jul. 14, 2016

(51) Int. Cl. G01G 19/07

(52) U.S. Cl. CPC G01G 19/07

(57) ABSTRACT

Managing a payload distribution for a flight includes specifying a flight with a payload distribution to be managed, obtaining, based on a flight timed event, historical payload data to determine a maximum takeoff weight limit for the flight, retrieving, based on the flight timed event, all planned payload values to determine an estimated takeoff weight for the flight, and obtaining, based on the flight timed event, actual payload values to manage the distribution of the payload for the flight.

### BACKGROUND

A load planner is utilized to plan the loading of an aircraft payload for a flight. The load planner performs weight and balance calculations for the payload to ensure the flight is within operating limits. Further, the load planner distributes the payload according to the weight and balance calculations for the flight. As a result, the flight's center of gravity and maximum takeoff weight limit are within operating limits of the flight.

### BRIEF DESCRIPTION OF THE DRAWINGS

The accompanying drawings illustrate various examples of the principles described herein and are a part of the specification. The examples do not limit the scope of the claims.

FIG. 1 is a diagram of an illustrative system for managing a payload distribution for a flight, according to one example of principles described herein.

FIG. 2 is a diagram of an illustrative management system, according to one example of principles described herein.

FIG. 3 is a diagram of an illustrative sequence for managing a payload distribution for a flight, according to one example of principles described herein.

FIG. 4 is a diagram of an illustrative database for a management system, according to one example of principles described herein.

FIG. 5 is a flowchart of an illustrative method for managing a payload distribution for a flight, according to one example of principles described herein.

FIG. 6 is a flowchart of an illustrative method for managing a payload distribution for a flight, according to one example of principles described herein.

FIG. 7 is a diagram of an illustrative management system, according to one example of principles described herein.

FIG. 8 is a diagram of an illustrative management system, according to one example of principles described herein.

Throughout the drawings, identical reference numbers designate similar, but not necessarily identical, elements.

### DETAILED DESCRIPTION

A load planner is a trained person who manually plans the loading and distribution of a payload for a flight. Such planning typically includes manually calculating weight and balance values for the flight. The weight and balance calculations account for the passengers, fuel, and cargo on board the aircraft to ensure the flight operates within intended limits. Further, the load planner manually distributes the payload within the aircraft according to the weight and balance calculations for the flight.

Manually performing weight and balance calculations for the flight can be a burdensome task for a load planner. Often, the flight may include hundreds of passengers. Manually calculating weight and balance values for hundreds of passengers, the fuel, and the cargo can be a time-consuming task.

If a passenger arrives late or unexpectedly, the load planner must verify that adding an extra passenger and their cargo still allows the flight to operate within the flight's intended operating limits. As a result, the load planner is required to recalculate weight and balance values to ensure the flight remains within operating limits.

Load planning activities typically take place within a given flight's lifecycle. A flight's lifecycle is a period of time associated with the flight having a beginning at a predetermined time prior to the flight, and an end at a selected time after the flight. In some instances, the load planning activities occur at specific times during the flight's lifecycle. Such times or points in the flight's lifecycle and the associated load planning activities are referred to herein as “flight timed events.” For example, at 24 hours, 12 hours, 1 hour, or 30 minutes prior to departure of a flight one or more load planning or balancing events may be scheduled to occur. The establishment of a given flight timed event can be determined or selected based on a number of parameters, such as airline protocols, government regulations, historical patterns, or user selection among others. In some instances, specific flight timed events may be determined by a schedule of optimal efficiency for load planning as determined by the illustrative methods and systems disclosed herein.

Consequently, the principles described herein include a method for managing the payload distribution for a flight. This method includes specifying details of the flight, such as the aircraft, destination, flying time, etc. Next, the method includes, obtaining, based on a flight timed event, historical payload data to determine a maximum takeoff weight limit for the flight, retrieving, based on the flight timed event, all planned payload values to determine an estimated takeoff weight for the flight, and obtaining, based on the flight timed event, actual payload values to manage the distribution of the payload for the flight. Such a method allows the payload to be distributed within the aircraft to ensure the flight is within operating limits. As a result, the flight's payload is consistently distributed within the flight.

Further, the method can include distributing the payload based on the actual payload values for the flight. Distributing the payload based on the actual payload values for the flight will be described in more detail below.

In the present specification and in the appended claims, the term “flight” is meant to be understood broadly as an aircraft in which a payload is distributed within a predetermined area of the flight. In one example, the flight may support passengers and cargo. Further, the cargo may be distributed in cargo bins in a predetermined area of the aircraft.

In the present specification and in the appended claims, the term “payload” is meant to be understood broadly as any weighted item that may be stored in an area for a flight. In one example, a payload may include passengers, carry-on items, fuel, cargo such as luggage, mail, packages, other payloads, or combinations thereof.

In the present specification and in the appended claims, the term “historical payload data” is meant to be understood broadly as discrete information of a payload for a typical flight. For example, a flight may have a historical payload data indicating that the payload, such as cargo, for the flight is typically 140,000 pounds.

In the present specification and in the appended claims, the term “planned payload data” is meant to be understood broadly as discrete information for a payload that is planned to be distributed for a flight. In one example, the planned payload data may include an estimated fuel weight, an estimated cargo weight, an estimated passenger weight, or combinations thereof.

In the present specification and in the appended claims, the term “actual payload data” is meant to be understood broadly as discrete information for a payload that is actually distributed in an area for a flight. In one example, the actual payload data may include an actual fuel weight, an actual cargo weight, an actual passenger weight, or combinations thereof.

Further, as used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

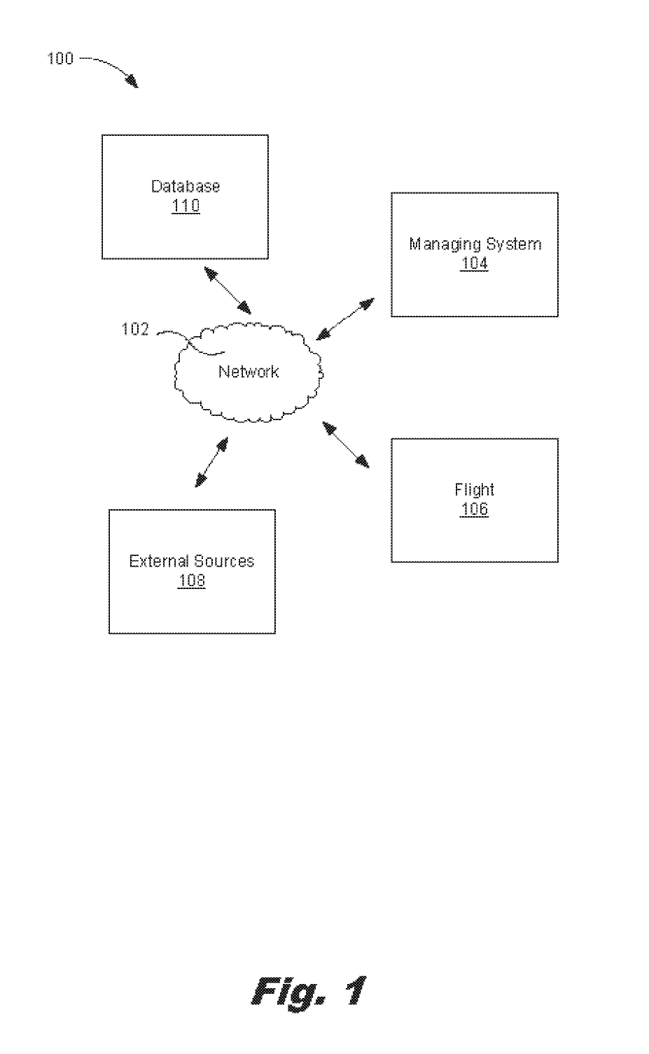

Referring now to the figures, FIG. 1 is a diagram of an example of a system for managing a distribution of a payload (i.e. payload distribution) for a flight, according to one example of principles described herein. As will be described below, a managing system is in communication over a network with a database, a flight, and external resources to manage the payload distribution for the flight. Further, the managing system retrieves, based on a flight timed event, all planned payload values to determine an estimated takeoff weight for the flight. Further, the managing system obtains, based on a flight timed event, actual payload values to manage the payload distribution for the flight.

As mentioned above, a managing system (104) is in communication over a network with a database (110), a flight (106), and external resources (108). As will be described below, the managing system (104) is used to manage the e payload distribution for the flight (106).

In one example, the managing system (104) references the database (110) to track the progress of managing the payload distribution for the flight (106). As will be described in later parts of this specification, the database (110) includes information to allow a controller of the managing system (104) to indicate the controller's status and determine if a flight can utilize the managing system (104).

As mentioned above, the system (100) includes a managing system (104). In one example, the managing system (104) specifies a flight (106) having a payload distribution to be managed. For example, the managing system (104) may specify a sub-fleet, equipment type, flight number, flight range, departure station, or combinations thereof.

In keeping with the given example, the managing system (104) obtains, based on a flight timed event, historical payload data to determine a maximum takeoff weight limit for the flight. For example, the managing system (104) may obtain, twenty-four hours from departure as specified by the flight timed event, the maximum takeoff weight limit for the flight (106) is 875,000 pounds.

In keeping with the given example, the managing system (104) retrieves, based on the flight timed event, all planned payload values to determine an estimated takeoff weight for the flight. For example, the managing system (104) retrieves, one and a half hours from departure as specified by the flight timed event, all planned payload values such as an estimated fuel weight, an estimated cargo weight, an estimated passenger weight, or combinations thereof for the flight (106).

The managing system (104) obtains, based on the flight timed event, actual payload values to manage the distribution of the payload for the flight. For example, the managing system (104) retrieves, thirty minutes from departure as specified by the flight timed event, actual payload values such as an actual fuel weight, an actual cargo weight, an actual passenger weight, or combinations thereof for the flight (106). In one example, the managing system (104) retrieves the actual payload values from external sources (108) such as ground services, station operations, cargo agents, ticketing agents, gate agents, catering agents, dispatchers, a load planner, fuelers, baggage handlers, ground handlers, other external sources, or combinations thereof. As a result, the managing system (104) allows the payload to be distributed within the flight (106) to ensure the flight (106) is within weight and center of gravity limits. More information about the managing system (104) will be described later on in this specification.

While this example has been described with reference to the managing system being located over the network, the managing system may be located in any appropriate location according to the principles described herein. For example, the managing system may be located in the database, the flight, other locations, or combinations thereof.

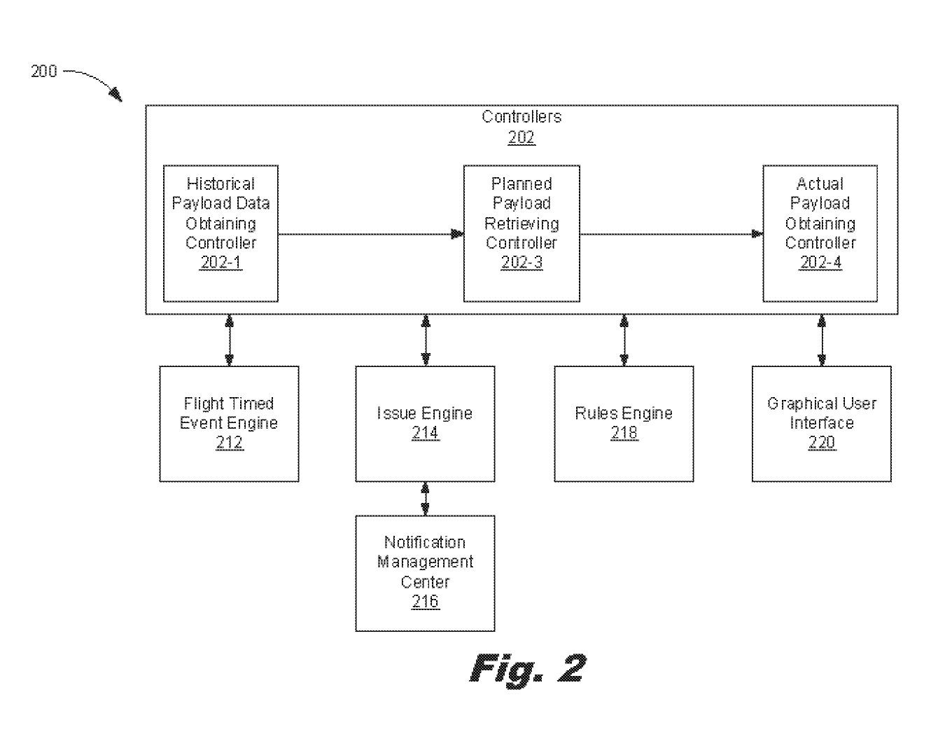

FIG. 2 is a diagram of an example of a managing system, according to one example of principles described herein. As mentioned above, a managing system is in communication over a network with a database, a flight, and external resources to manage a payload distribution for a flight. As will be described below, the managing system manages the payload distribution for the flight based on flight timed events and specifies distribution of the planned payload according specifications of an airline carrier. In this way, the cargo bins for the planned payload are distributed in a way that optimizes an aircraft's center of gravity for the flight. Further, the cargo bins for the planned payload are within a weight limit of the flight.

As illustrated in FIG. 2, the managing system (200) includes a number of controllers (202). The controllers (202) orchestrate the tasks and activities that are used to manage the distribution of the payload for the flight based on a flight timed event. Further, the controllers (202) refer to a combination of hardware and program instructions to perform a designated function. Each of the controllers (202) may include a processor and memory. The program instructions are stored in the memory and cause the processor to execute the designated function of the controllers (202).

As illustrated, the controllers (202) include a historical payload data obtaining controller (202-1). The historical payload data obtaining controller (202-1) obtains, based on a flight timed event, historical payload data to determine a maximum takeoff weight limit for the flight. In one example, the flight timed event engine (212) determines when the historical payload data is obtained. For example, the flight timed event engine (212) determines the historical payload data is obtained at a specific time before the flight departs, such as twenty-four hours before departure.

The historical payload data obtaining controller (202-1) orchestrates the tasks and activities that are used to obtain, based on a flight timed event, historical payload data to determine a maximum takeoff weight limit for the flight. If the historical payload data obtaining controller (202-1) fails to obtain, based on a flight timed event, historical payload data to determine the maximum takeoff weight limit for the flight, an issues engine (214) may alert a notification management center (216) of the issue. As a result, the tasks and activities of the historical payload data obtaining controller (202-1) are stopped until the issue is resolved.

Further, the managing system (200) may include a graphical user interface (220) (GUI) to determine the status of the historical payload data obtaining controller (202-1). For example, the GUI (220) may indicate that the status of the historical payload data obtaining controller (202-1) has not started, is in progress, is stopped, is aborted due to an application or system error, or is completed.

As illustrated, the controllers (202) include a planned payload retrieving controller (202-3). The planned payload retrieving controller (202-3) retrieves based on the flight timed event, all planned payload values to determine an estimated takeoff weight for the flight. Further, all planned payload values may be retrieved in real-time. In one example, the flight timed event engine (212) determines when all planned payload values are retrieved. For example, the flight timed event engine (212) determines the all planned payload values are retrieved at a specific time before the flight departs, such as one hour before departure.

The planned payload retrieving controller (202-3) orchestrates the tasks and activities that are used to retrieve all planned payload values to determine an estimated takeoff weight for the flight. If the planned payload retrieving controller (202-3) fails to retrieve all planned payload values to determine an estimated takeoff weight for the flight, an issues engine (214) may alert a notification management center (216) of the issue. As a result, the tasks and activities of the planned payload retrieving controller (202-3) are stopped until the issue is resolved.

As mentioned above, the managing system (200) may include the GUI (220) to determine the status of the planned payload retrieving controller (202-3). For example, the GUI (220) may indicate that the status of the planned payload retrieving controller (202-3) has not started, is in progress, is stopped, is aborted due to an application or system error, or is completed.

As illustrated, the controllers (202) include an actual payload obtaining controller (202-4). The actual payload obtaining controller (202-4) obtains, based on the flight timed event, actual payload values to manage the distribution of the payload for the flight. In one example, the flight timed event engine (212) determines when the actual payload values are obtained. For example, the flight timed event engine (212) determines the actual payload values are obtained at a specific time before the flight departs, such as thirty minutes before departure.

The actual payload obtaining controller (202-4) orchestrates the tasks and activities that are used to obtain actual payload values to manage the distribution of the payload for the flight. If the actual payload obtaining controller (202-4) fails to retrieve the actual payload values to manage the distribution of the payload for the flight, an issues engine (214) may alert a notification management center (216) of the issue. As a result, the tasks and activities of the actual payload obtaining controller (202-4) are stopped until the issue is resolved.

As mentioned above, the managing system (200) may include the GUI (220) to determine the status of the actual payload obtaining controller (202-4). For example, the GUI (220) may indicate that the status of the actual payload obtaining controller (202-4) has not started, is in progress, is stopped, is aborted due to an application or system error, or is completed.

As mentioned above, the planned payload obtaining controller (202-3) orchestrates the task and activities that are used to obtain planned payload values to manage the payload distribution for the flight. In one example, the planned payload obtaining controller (202-3) orchestrates the task and activities according to a rules engine (218). In one example, the rules engine (218) includes an airline carrier's payload distribution rules to ensure the payload is distributed based on the airline carrier specifications, and ensure the cargo bins are within weight limits while also striving to optimize the aircraft's center of gravity.

As a result, the managing system (200) manages the payload distribution for the flight based on flight timed events and distributes the payload according to an airline carrier's payload distribution rules to ensure the payload is distributed based on the airline carrier specifications.

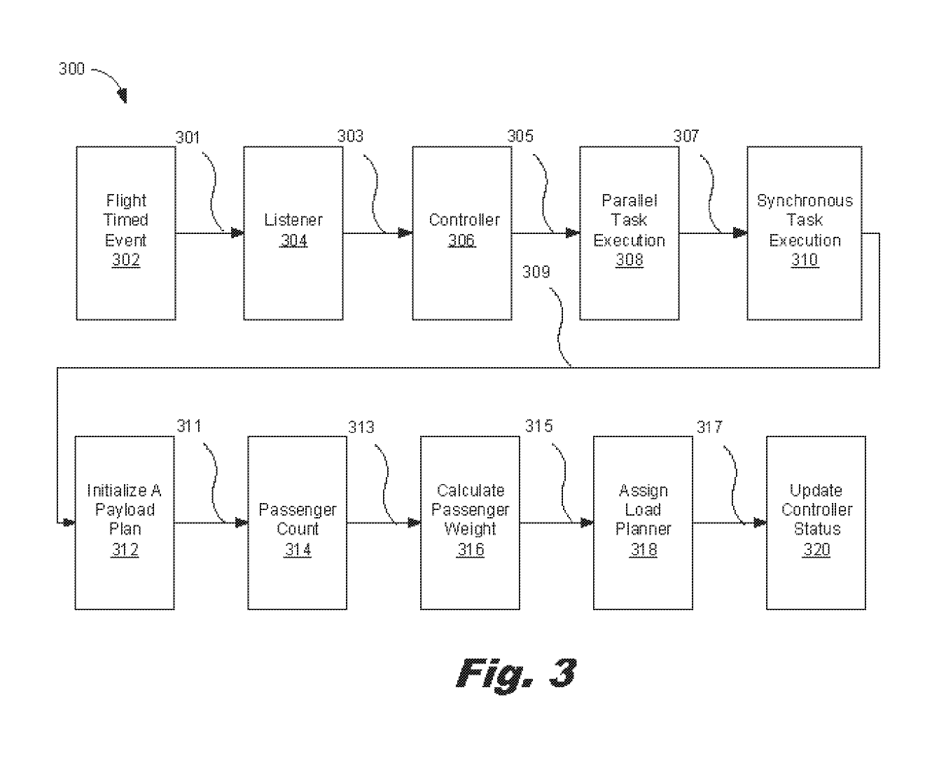

FIG. 3 is a diagram of an example of a sequence for managing a payload distribution for a flight, according to one example of principles described herein. As mentioned above, the managing system manages the payload distribution for the flight based on flight timed events and distributes the payload according to payload distribution rules for an airline carrier to ensure the payload is distributed based on the airline carrier specifications. Further, the managing system includes a number of controllers to orchestrate the tasks and activities that are used to manage the payload distribution for the flight based on flight timed events.

A sequence for managing a payload distribution for a flight will now be described in reference to FIG. 3. As mentioned above, a flight timed event specifies a time for a controller to orchestrate the tasks and activities for which it is responsible. As illustrated, a flight timed event (302) may specify or dictate a specific time for a controller to orchestrate the tasks and activities for which it is responsible (306). As illustrated, a listener (304) determines, as indicated by arrow 301, when the flight timed event (304) is to commence. If the flight timed event (304) is to commence, the listener (304), alerts a controller (306) as indicated by arrow 303.

Depending on the flight timed event (302), the listener (304) may alert a controller (306) such as a historical payload data obtaining controller. As mentioned above, the historical payload data obtaining controller orchestrates the tasks and activities that are used to obtain, historical payload data to determine a maximum takeoff weight limit for the flight. As illustrated the tasks or activities may be executed in parallel (308) or synchronous (310).

In another example, depending on the flight timed event (302), the listener (304) may alert a controller (306) such as planned payload retrieving controller in real-time. As mentioned above, the planned payload retrieving controller orchestrates the tasks and activities that are used to retrieve, based on the flight timed event, all planned payload values to determine an estimated takeoff weight for the flight. As illustrated the tasks or activities may be executed in parallel (308) or synchronous (310).

In yet another example, depending on the flight timed event (302), the listener (304) may alert a controller (306) such an actual payload obtaining controller. As mentioned above, the an actual payload obtaining controller orchestrates the tasks and activities that are used to obtain, based on the flight timed event, actual payload values to manage the payload distribution for the flight. As illustrated the tasks or activities may be executed in parallel (308) or synchronous (310).

As illustrated, the sequence (300) further initializes a payload plan (312). Depending on the controller (306) used, the payload plan may include a payload plan for historical payload data, all planned payload values, or actual payload values.

As illustrated, the sequence (300) further includes a passenger count (314). Depending on the controller (306) used, the passenger count (314) may include a historical passenger count, a planned passenger count, or an actual passenger count.

As illustrated, the sequence (300) further includes calculating a passenger weight (316). In one example, the passenger weight (316) may be an average weight. For example, the passenger weight (316) may be an average passenger weight of one-hundred eighty pounds per passenger.

Further, the passenger weight (316) may include all carry on items that a passenger carries on the flight. For example, if the flight is departing a tropical location and heading to a tropical location, a passenger may not carry on items for the flight. As a result, the passenger weight may be one-hundred eighty pounds per passenger. In another example, if the flight is departing from a tropical location and heading to a winter location, a passenger may carry on heavy items such as a coat for the flight. As a result, the passenger weight may be one-hundred ninety pounds per passenger.

As illustrated, the sequence (300) further includes assigning a load planner (318). In each case, one load planner is assigned to a flight for monitoring purposes.

As illustrated, the sequence (300) further includes updating the controller status (320). In one example, the status of the controller may be updated to alert the load planner if a specific controller has not started, is in progress, is stopped, is aborted due to an application or system error, or is completed.

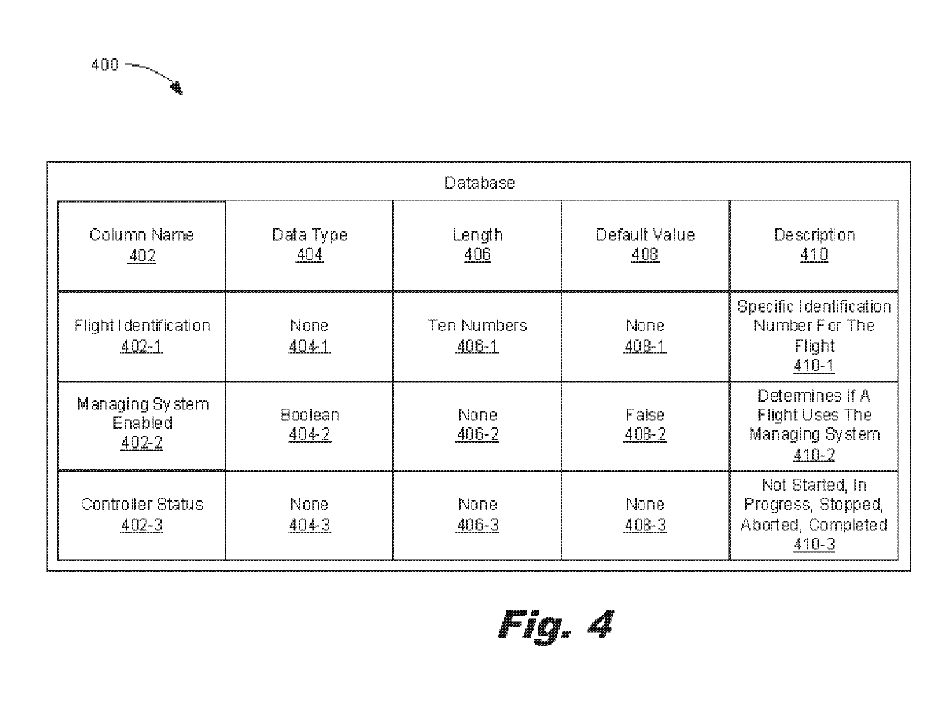

FIG. 4 is a diagram of an example of a database for a managing or management system, according to one example of principles described herein. As mentioned above, the management system references the database to track the progress of managing the distribution of the payload for the flight. The database includes information to allow a controller of the management system to indicate the controller's status, determine if a flight can utilize the management system, and indicate status when executed.

In one example, the database (400) may include a column name (402). As illustrated, the column name (402) may include three entries such as flight identification (402-1), managing system enabled (402-2), and a controller status (402-2).

As illustrated, the flight identification (402-1) is associated with a length (406). In this example, the length (406) may be ten numbers (406-1). Further, the flight identification (402-1) is associated with a description (410). In this example the description (410) indicates that the flight identification (402-1) is a specific (410-1) identification number for the flight.

As illustrated, the managing system enabled is associated with a data type (404). In this example, the data type (404) is a Boolean (404-2). Further, the managing system enabled (402-2) has a default value (408) of false (408-2). The managing system enabled (402-2) is further associated with a description (410). In this example the description (410) indicates that the managing system enabled (402-2) determines if a flight uses the managing system.

As illustrated, the controller status (402-3) is associated with a description (410). In this example the description (410) indicates that the status (402-3) of a controller has not started, is in progress, is stopped, is aborted due to an application or system error, or is completed.

While this example has been described with reference to a database containing three entries, the database may contain multiple entries.

For example, the database may include fifty entries.

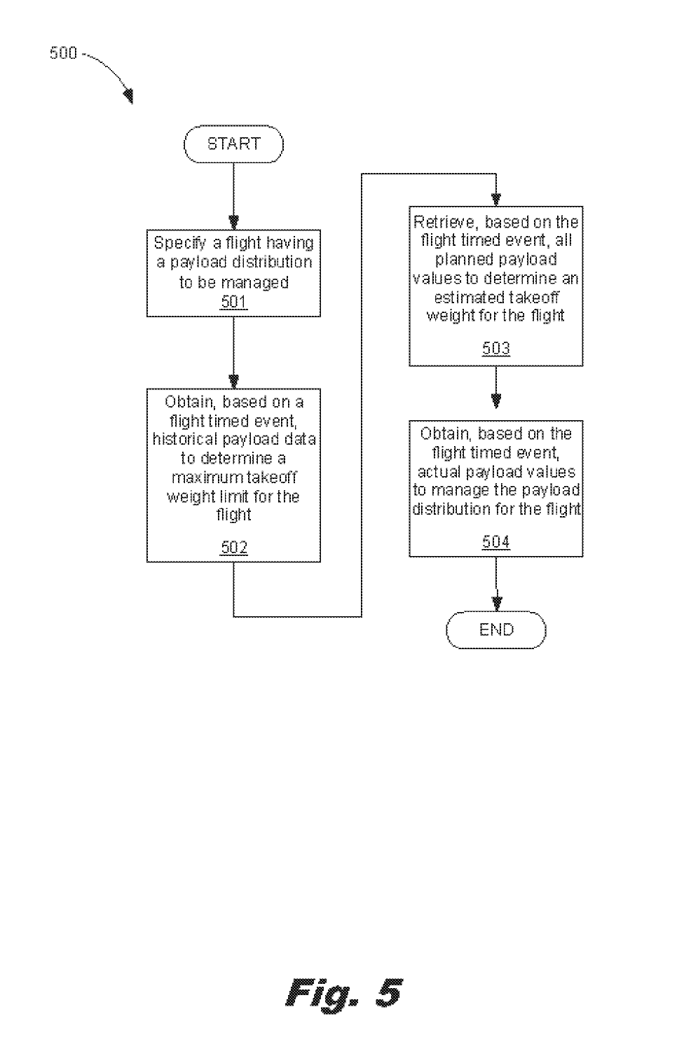

FIG. 5 is a flowchart of an example of a method for managing a payload distribution for a flight, according to one example of principles described herein. In one example, the method (500) may be executed by the system (200) of FIG. 2. In other examples, the method (500) may be executed by other systems described herein (e.g., system 700, system 800, etc.). In one example, the method includes specifying (501) a flight with a payload distribution to be managed, obtaining (502), based on a flight timed event, historical payload data to determine a maximum takeoff weight limit for the flight, retrieving (503), based on the flight timed event, all planned payload values to determine an estimated takeoff weight for the flight, and obtaining (504), based on the flight timed event, actual payload values to manage the distribution of the payload for the flight.

As mentioned above, the method (500) includes specifying (501) a flight with a payload distribution to be managed. In one example, an administrator may specify a flight with a payload distribution to be managed. In another example, the managing system of FIG. 2 may obtain information from a database that specifies a flight with a payload distribution to be managed. Further, any appropriate mechanism may be used to specify a flight with a payload distribution to be managed.

In one example, specifying a flight with a payload distribution to be managed includes specifying a sub-fleet, equipment type, flight number, flight range, departure station, or combinations thereof. In one example, a sub-fleet may include a number of aircrafts that supports passengers and cargo.

In keeping with the given example, an equipment type may include the type of equipment the flight uses. For example, the equipment type may specify that the flight use a particular sub-fleet from airline carrier X such as a 737-800 on the flight. Further, the equipment type may specify that the flight includes specifications for the aircraft and a capacity used to hold payload.

In this example, the flight number may be used to identify which flights utilize the method (500). In one example, the flight number may specify the airline carrier of the flight. For example, airline carrier X. Further, the flight number may further distinguish a flight from other flights by including several numbers after the name of the airline carrier. For example, a flight number may be airline carrier X 1144.

Further, a flight range may be specified. For example, the flight range identifies a range of flight numbers. In one example, a flight range may include numbers between 1500 and 2500 for a specific airline carrier.

As mentioned above, a departure station may be specified. For example, the departure station may specify the flight is departing from station X. In another example, the departure station may specify the flight is departing from station Y. As a result, by specifying a flight departure station, a specific flight with a payload distribution to be managed may be identified.

As mentioned above, the method (500) includes obtaining (502), based on a flight timed event, historical payload data to determine a maximum takeoff weight limit for the flight. In one example, if a flight number is specified, the flight number may indicate that the flight is a 747 jetliner. In this example, the jetliner may have a maximum takeoff weight limit of 987,000 pounds. Further, the historical payload data may indicate the 747 jetliner has an empty weight of 840,000 pounds. As a result, the 747 jetliner may receive a maximum payload of 147,000 pounds. In one example, the managing system obtains historical payload data to determine a maximum takeoff weight limit for the flight twenty-four hours before departure as indicated by the flight timed event.

As mentioned above, an issues engine may alert a notification management center if the method (500) fails to obtain, based on a flight timed event, historical payload data to determine a maximum takeoff weight limit for the flight. As a result, the method (500) is stopped until the issue is resolved.

As mentioned above, the method (500) includes retrieving (503), based on the flight timed event, all planned payload values to determine an estimated takeoff weight for the flight. In one example, the flight may be scheduled with one hundred passengers. In this example, an estimated fuel weight, an estimated cargo weight, an estimated passenger weight, or combinations thereof are retrieved to determine an estimated takeoff weight for the flight. In one example, the managing system receives the planned payload values for the flight one hour before departure as indicated by the flight timed event. Further, the planned payload values may be received in real-time.

In one example, an issues engine may alert a notification management center if the method (500) fails to retrieve, based on the flight timed event, all planned payload values to determine an estimated takeoff weight for the flight. As a result, the method (500) is stopped until the issue is resolved.

As mentioned above, the method (500) includes obtaining (504), based on the flight timed event, actual payload values to manage the distribution of the payload for the flight. In one example, the method (500) obtains actual payload values such as an actual fuel weight, an actual cargo weight, an actual passenger weight, or combinations thereof. In this example, the managing system retrieves the actual payload values from external sources such as ground services, station operations, cargo agents, ticketing agents, gate agents, catering agents, dispatchers, load planners, fuelers, baggage handlers, ground handlers, other external sources, or combinations thereof. Further, the actual payload values may be received in real-time.

In one example, an issues engine may alert a notification management center if the method (500) fails to obtain, based on the flight timed event, actual payload values to manage the distribution of the payload for the flight. As a result, the method (500) is stopped until the issue is resolved.

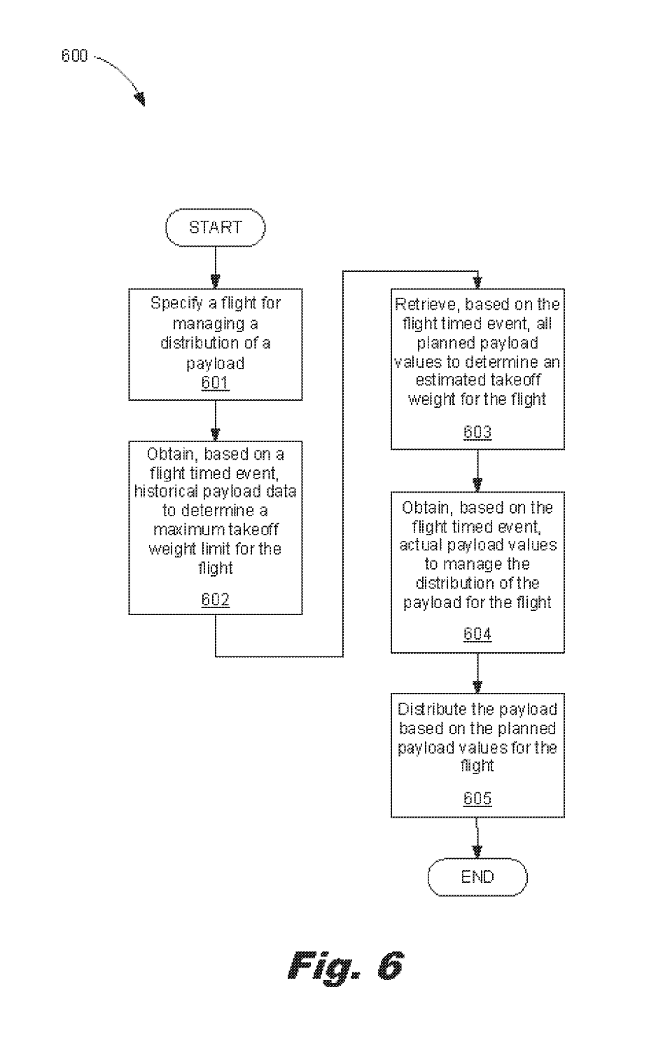

FIG. 6 is a flowchart of an example of a method for managing a payload distribution for a flight, according to one example of principles described herein. In one example, the method (600) may be executed by the system (200) of FIG. 2. In other examples, the method (500) may be executed by other systems described herein (e.g., system 700, system 800, etc.). In one example, the method includes specifying (601) a flight with a payload distribution to be managed, obtaining (602), based on a flight timed event, historical payload data to determine a maximum takeoff weight limit for the flight, retrieving (603), based on the flight timed event, all planned payload values to determine an estimated takeoff weight for the flight, obtaining (604), based on the flight timed event, actual payload values to manage the payload distribution for the flight, and distributing (605) the payload in the aircraft based on the planned payload values for the flight.

As mentioned above, the method (600) includes distributing (606) the payload based on the planned payload values for the flight. In one example, distributing the payload based on the planned payload values for the flight includes distributing the planned payload according to specifications of an airline carrier to ensure the cargo bins for the planned payload are distributed to optimize an aircraft's center of gravity for the flight and the cargo bins for the planned payload are within a weight limit of the flight

In one example, an issues engine may alert a notification management center if the method (600) fails to distribute the payload based on the planned payload values for the flight. As a result, the method (600) is stopped until the issue is resolved.

Further, distributing (606) the payload based on the planned payload values for the flight further includes once the payload is distributed, making final checks to ensure the flight is within operating limits. For example, a center of gravity and a weight limit for the flight. If the flight is within operating limits, a Cargo Load Plan is generated to the station. Furthermore, after the actual payload has been received, and if the flight is within center of gravity and weight limits, a close out message is sent to a pilot. The close out message indicates that the payload is distributed within a predetermined area of the flight and the flight is within operating limits. Further, once the dose out message is sent, the management system of FIG. 1 detects if there are any updates to the payload. Further, if the management system of FIG. 1 detects any updates to the payload, the it alerts the pilot, load planner, other personal, or combinations thereof accordingly.

As a result, the method (600) drives the flight through the entire process of managing a distribution of a payload including inputs, distributions of payload, and product outputs. Further, the method (600) allows an audit trail for managing a distribution of a payload for the flight outside of a general flight history.

FIG. 7 is a diagram of an example of a management system, according to one example of principles described herein. The management system (700) includes a flight specifying engine (702), a historical payload data obtaining engine (704), a planned payload retrieving engine (706), an actual payload data obtaining engine (708). In this example, the management system (700) also includes a payload distribution engine (710) and an issue determining engine (712). The engines (702, 704, 706, 708, 710, 712) refer to a combination of hardware and program instructions to perform a designated function. Each of the engines (702, 704, 706, 708, 710, 712) may include a processor and memory. The program instructions are stored in the memory and cause the processor to execute the designated function of the engine.

The flight specifying engine (702) specifies a flight with a payload distribution to be managed. In one example, flight specifying engine (702) specifies a sub-fleet, equipment type, flight number, flight range, departure station, or combinations thereof.

The historical payload data obtaining engine (704) obtains, based on a flight timed event, historical payload data to determine a maximum takeoff weight limit for the flight. In one example, the flight timed event for the historical payload data obtaining engine (704) indicates the historical payload data obtaining engine (704) is to commence according to a specific time before the flight departs.

The planned payload retrieving engine (706) retrieves, based on the flight timed event, all planned payload values to determine an estimated takeoff weight for the flight. In one example, the planned payload retrieving engine (708) retrieves estimated fuel weight, an estimated cargo weight, an estimated passenger weight, or combinations thereof for the flight. In one example, flight timed event for the planned payload retrieving engine (708) indicates the planned payload retrieving engine (708) is to commence according to a specific time before the flight departs. Further, all planned payload values are received in real-time.

The actual payload data obtaining engine (708) obtains, based on the flight timed event, actual payload values to manage the distribution of the payload for the flight. In one example, the actual payload data obtaining engine (710) obtains an actual fuel weight, an actual cargo weight, an actual passenger weight, or combinations thereof for a flight. In one example, flight timed event for the actual payload data obtaining engine (710) indicates the actual payload data obtaining engine (710) is to commence according to a specific time before the flight departs. Further, the actual payload values are received in real-time.

The payload distribution engine (710) distributes the payload based on the actual payload values for the flight. In one example, the payload distribution engine (712) distributes the planned payload according specifications of an airline carrier to ensure the cargo bins for the planned payload are distributed to optimize an aircraft's center of gravity for the flight and the cargo bins for the planned payload are within a weight limit of the flight.

The issue determining engine (712) determines if there is an issue with managing the distribution of the payload. In this example, the issue determining engine (714) determines if there is an issue with the historical payload data obtaining engine (704),), the planned payload retrieving engine (706), the actual payload data obtaining engine (708), or combinations thereof. Further, the issue determining engine (714) stops the tasks and activities of the engines (702, 704, 706, 708, 710, 712) until the issue is resolved.

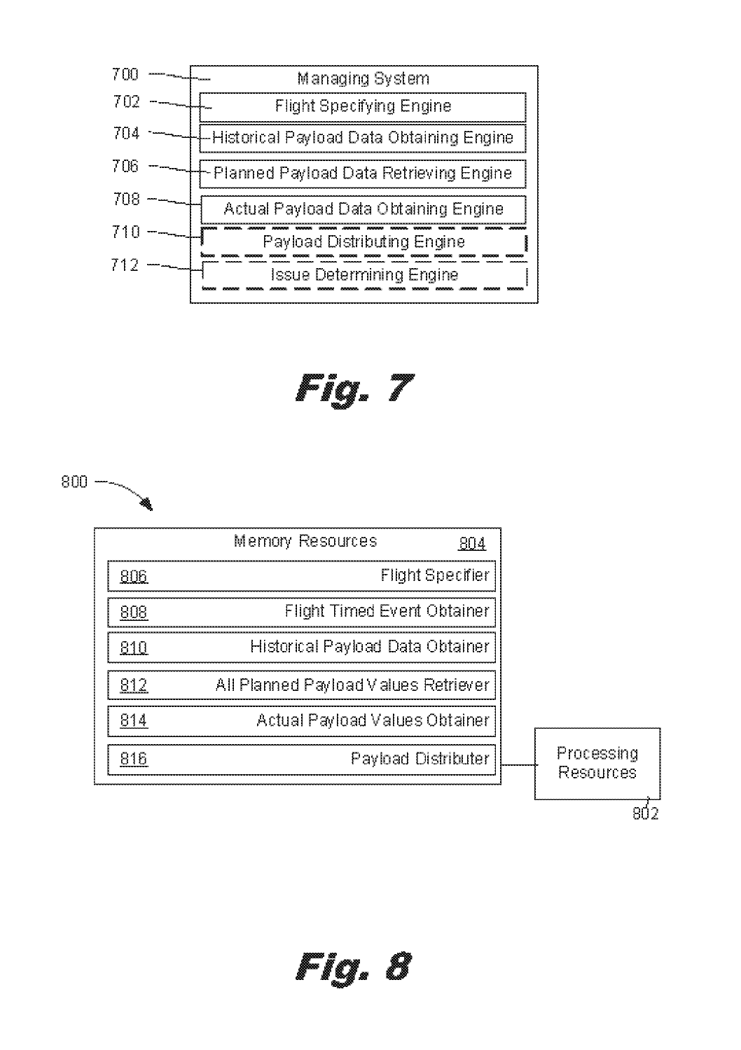

FIG. 8 is a diagram of an example of a management system, according to one example of principles described herein. In this example, management system (800) includes processing resources (802) that are in communication with memory resources (804). Processing resources (802) include at least one processor and other resources used to process programmed instructions. The memory resources (804) represent generally any memory capable of storing data such as programmed instructions or data structures used by the managing system (800). The programmed instructions shown stored in the memory resources (804) include a flight specifier (806), a flight timed event obtainer (808), a historical payload data obtainer (810), an all planned payload values retriever (812), an actual payload values obtainer (814), and a payload distributer (816).

The memory resources (804) include a computer readable storage medium that contains computer readable program code to cause tasks to be executed by the processing resources (802). The computer readable storage medium may be tangible and/or physical storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, or types of memory, or combinations thereof.

The flight specifier (806) represents programmed instructions that, when executed, cause the processing resources (802) to specify a flight for managing a payload distribution. The flight timed event obtainer (808) represents programmed instructions that, when executed, cause the processing resources (802) to obtain a flight timed event. The historical payload data obtainer (810) represents programmed instructions that, when executed, cause the processing resources (802) to obtain, based on a flight timed event, historical payload data to determine a maximum takeoff weight limit for the flight.

The all planned payload values retriever (812) represents programmed instructions that, when executed, cause the processing resources (802) to retrieve, based on the flight timed event, all planned payload values to determine an estimated takeoff weight for the flight.

The actual payload values obtainer (814) represents programmed instructions that, when executed, cause the processing resources (802) to obtain, based on the flight timed event, actual payload values to manage the distribution of the payload for the flight. The payload distributer (816) represents programmed instructions that, when executed, cause the processing resources (802) to distribute the payload based on the actual payload values for the flight.

Further, the memory resources (804) may be part of an installation package. In response to installing the installation package, the programmed instructions of the memory resources (804) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (802) and the memory resources (802) are located within the same physical component, such as a server, or a network component. The memory resources (804) may be part of the physical component's main memory, caches, registers, non-volatile memory, or elsewhere in the physical component's memory hierarchy. Alternatively, the memory resources (804) may be in communication with the processing resources (802) over a network. Further, the data structures, such as the libraries, may be accessed from a remote location over a network connection while the programmed instructions are located locally. Thus, the managing system (800) may be implemented on a user device, on a server, on a collection of servers, or combinations thereof.

The management system (800) of FIG. 8 may be part of a general purpose computer. However, in alternative examples, the management system (800) is part of an application specific integrated circuit.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method for managing a payload distribution for a flight, the method comprising:
specifying a flight having a payload distribution to be managed;
obtaining, based on a flight timed event, historical payload data to determine a maximum takeoff weight limit for the flight;
retrieving, based on the flight timed event, all planned payload values to determine an estimated takeoff weight for the flight; and
obtaining, based on the flight timed event, actual payload values to manage the payload distribution for the flight.

2. The method of claim 1, wherein specifying the flight comprises specifying a sub-fleet, an equipment type, a flight number, a flight range, a departure station, or combinations thereof.

3. The method of claim 1, wherein planned payload values include an estimated fuel weight, an estimated cargo weight, an estimated passenger weight, or combinations thereof.

4. The method of claim 1, wherein actual payload values include an actual fuel weight, an actual cargo weight, an actual passenger weight, or combinations thereof.

5. The method of claim 1, further comprising distributing the payload in an aircraft based on the planned payload values for the flight.

6. The method of claim 5, wherein distributing the payload based on the planned payload values for the flight comprises distributing the planned payload according to specifications of an airline carrier to ensure that cargo bins for the planned payload are distributed to optimize the aircraft's center of gravity for the flight, and are within a weight limit of the flight.

7. The method of claim 1, wherein the flight timed event commences according to a specific time before the flight departs.

8. The method of claim 1, further comprising determining if there is an issue with managing the distribution of the payload.

9. A system for managing a payload distribution for a flight, the system comprising:
a flight specifying engine to specify a flight with a payload distribution to be managed;
a historical payload data obtaining engine to obtain, based on a flight timed event, historical payload data to determine a maximum takeoff weight limit for the flight;
a planned payload retrieving engine to retrieve, based on the flight timed event, all planned payload values to determine an estimated takeoff weight for the flight;
an actual payload data obtaining engine to obtain, based on the flight timed event, actual payload values to manage the payload distribution for the flight;
a payload distribution engine to indicate distribution of the payload in an aircraft based on the actual payload values for the flight; and
an issue determining engine to determine if there is an issue with managing the payload distribution.

10. The system of claim 9, wherein the payload distribution engine indicates distribution of the planned payload according to specifications of an airline carrier to ensure that cargo bins for the planned payload are distributed in a way that optimizes the aircraft's center of gravity for the flight, and are within a weight limit specified for the flight.

11. The system of claim 9, wherein the flight specifying engine further specifies a sub-fleet, an equipment type, a flight number, a flight range, a departure station, or combinations thereof.

12. The system of claim 9, wherein the flight timed event commences according to a specific time before the flight departs.

13. A computer program product for managing a payload distribution for a flight, comprising:
a tangible computer readable storage medium, said tangible computer readable storage medium comprising computer readable program code embodied therewith, said computer readable program code comprising program instructions that, when executed, causes a processor to:
specify a flight with a payload distribution to be managed;
retrieve, based on a flight timed event, all planned payload values to determine an estimated takeoff weight for the flight; and
obtain, based on the flight timed event, actual payload values to manage the distribution of the payload for the flight.

14. The product of claim 13, further comprising computer readable program code comprising program instructions that, when executed, cause said processor to:
obtain, based on the flight timed event, historical payload data to determine a maximum takeoff weight limit for the flight; and
indicate distribution of the payload in an aircraft based on the actual payload values for the flight.

15. The product of claim 13, further comprising computer readable program code comprising program instructions that, when executed, cause said processor to specify a sub-fleet, an equipment type, a flight number, a flight range, a departure station, or combinations thereof.
